(19) United States
(12) Patent Application Publication
(10) Pub. No.: US 2020/0272906 A1
(43) Pub. Date: Aug. 27, 2020

(54) DISCRIMINANT MODEL GENERATION DEVICE, DISCRIMINANT MODEL GENERATION METHOD, AND DISCRIMINANT MODEL GENERATION PROGRAM

(71) Applicant: NEC Corporation, Tokyo (JP)

(72) Inventor: Akira TANIMOTO, Tokyo (JP)

(73) Assignee: NEC Corporation, Tokyo (JP)

(21) Appl. No.: 16/761,568

(22) PCT Filed: Jul. 24, 2018
(86) PCT No.: PCT/JP2018/027610

§ 371 Date: May 5, 2020

(30) Foreign Application Priority Data
Nov. 7, 2017 (JP) 2017-214687

(51) Int. Cl. G06N 3/08; G06N 3/04

(52) U.S. Cl. CPC G06N 3/088; G06N 3/0454

(57) ABSTRACT

A discriminant model generation device 80 includes a calculation unit 81 and a learning unit 82. The calculation unit 81 calculates a label to be added to learning data, in accordance with a difference between a threshold value for discriminating a positive example or a negative example and a value of an objective variable included in the learning data. The learning unit 82 learns a discriminant model by using learning data associated with a calculated label.

### TECHNICAL FIELD

The present invention relates to a discriminant model generation device, a discriminant model generation method, and a discriminant model generation program, for generating a discriminant model on the basis of learning data.

### BACKGROUND ART

In order to discriminate a current or future predicted situation, a model used for discrimination is generated from learning data. Specifically, there is a case of generating a model for discriminating a target case on the basis of whether or not an objective variable y is greater than a threshold value θ, when the objective variable y is expressed by a numerical value.

Examples of a such case include, for example, whether or not a certain state value y is to reach a risk level θ, whether or not an evaluation value y of a restaurant is to be equal to or higher than a high evaluation θ, and whether or not sales are to be equal to or more than a certain number 0 in one week after release of a new product.

For example, PTL 1 describes a device for learning an identifier for identifying a person or an object remaining in a monitoring area. The device described in PTL 1 learns an identifier for identifying whether or not a detection target is remaining, while using an image indicating that a detection target is remaining as a positive example, and an image indicating that a detection target is not remaining as a negative example. By using the identifier generated in this way, it becomes possible to obtain a remaining degree that indicates certainty belonging to a positive example or a negative example for any given input image.

Whereas, PTL 2 describes an active studying method in machine learning. In the active studying method described in PTL 2, a weight is set for studying data in accordance with an acquiring order of studying data, and studying is performed in which newly acquired data is given more importance than previously accumulated data.

### CITATION LIST

### Patent Literature

PTL 1: International Publication No. 2016/136214

PTL 2: International Publication No. 2008/072459

### SUMMARY OF INVENTION

### Technical Problem

As a method for discriminating a situation, a method of performing regression analysis and discriminating a prediction value with a generated prediction model can be considered as one idea. However, in a situation of discriminating whether or not a certain state occurs, accuracy of an objective variable itself is not always necessary. For example, in a situation where there is little data indicating a positive example, accuracy of a region of no interest may reduce accuracy of a region of interest.

For example, consider a case where it is discriminated whether or not a traffic accident occurs. In general, situations where traffic accidents occur are significantly less than situations where no traffic accident occurs. When regression analysis is performed in such a case, even though a situation where a traffic accident occurs is the region of interest, a model is generated that fits most a situation where no traffic accident occurs. Whereas, in the device described in PTL 1, the identifier is learned based on learning data that is labeled in advance as a positive example and a negative example. Meanwhile, as learning data used for learning an identifier, an actual measured value of an identification target (objective variable) included in learning data may be obtained as the actual measured value itself in some cases, rather than a binary value of a positive example (for example, 1) or a negative example (for example, 0).

In such a case, for example, it is conceivable to perform learning after converting a value that can be obtained as numerical data, from the numerical data into a binary value of a positive example (1) or a negative example (0). However, such a conversion reduces a value to 0 or 1 even though the numerical data can be used, which may reduce an amount of usable information and cause an adverse effect on model discrimination accuracy.

In order to generate a discriminant model, it is preferable that more learning data can be used. However, even when an amount of learning data is small, it is desired that a highly accurate model can be learned with use of the small amount of learning data more efficiently.

Therefore, an object of the present invention is to provide a discriminant model generation device, a discriminant model generation method, and a discriminant model generation program that can learn a highly accurate discriminant model even when learning data is small.

### Solution to Problem

A discriminant model generation device according to the present invention includes: a calculation unit that calculates a label to be added to learning data, in accordance with a difference between a threshold value for discriminating a positive example or a negative example and a value of an objective variable included in the learning data; and a learning unit that learns a discriminant model by using learning data associated with a calculated label.

A discriminant model generation method according to the present invention calculates a label to be added to learning data, in accordance with a difference between a threshold value for discriminating a positive example or a negative example and a value of an objective variable included in the learning data.

A discriminant model generation program according to the present invention causes a computer to execute a calculation process of calculating a label to be added to learning data, in accordance with a difference between a threshold value for discriminating a positive example or a negative example and a value of an objective variable included in the learning data; and a learning process of learning a discriminant model by using learning data associated with a calculated label.

### Advantageous Effects of Invention

According to the present invention, there is provided a technical effect that a highly accurate discriminant model can be learned even when learning data is small.

### BRIEF DESCRIPTION OF DRAWINGS

FIG. 1 It depicts a block diagram showing a configuration example of a first exemplary embodiment of a discriminant model generation device according to the present invention.

FIG. 2 It depicts an explanatory view showing an example of learning data.

FIG. 3 It depicts an explanatory view showing an example of a result of calculating a label on the basis of learning data.

FIG. 4 It depicts a flowchart showing an operation example of the discriminant model generation device of the first exemplary embodiment.

FIG. 5 It depicts a block diagram showing a configuration example of a second exemplary embodiment of a discriminant model generation device according to the present invention.

FIG. 6 It depicts an explanatory view showing an example of a process for generating positive example data and negative example data from learning data.

FIG. 7 It depicts an explanatory view showing an example of a result of calculating a weight on the basis of learning data.

FIG. 8 It depicts a flowchart showing an operation example of the discriminant model generation device of the second exemplary embodiment.

FIG. 9 It depicts a block diagram showing a configuration example of a third exemplary embodiment of a discriminant model generation device according to the present invention.

FIG. 10 It depicts a flowchart showing an operation example of the discriminant model generation device of the third exemplary embodiment.

FIG. 11 It depicts a block diagram showing an exemplary embodiment of a label generation device according to the present invention.

FIG. 12 It depicts an explanatory view showing a distribution of learning data in an example.

FIG. 13 It depicts an example of a result of classifying samples into positive example data and negative example data on the basis of a threshold value.

FIG. 14 It depicts an explanatory view showing an example of an evaluation result.

FIG. 15 It depicts a block diagram showing an outline of a discriminant model generation device according to the present invention.

### DESCRIPTION OF EMBODIMENTS

Hereinafter, an exemplary embodiment of the present invention will be described with reference to the drawings. A discriminant model generated in the present exemplary embodiment is assumed to be a model for discriminating whether or not an objective variable y as a discrimination target (prediction target) exceeds a certain threshold value θ (that is, y>θ is satisfied), when the objective variable y is expressed by a numerical value as described above.

### First Exemplary Embodiment

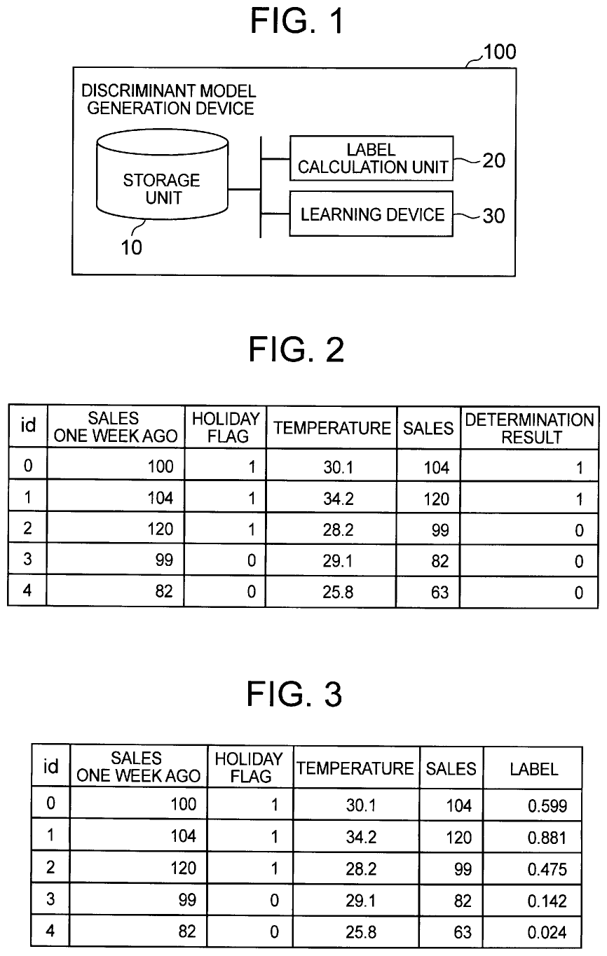

FIG. 1 is a block diagram showing a configuration example of a first exemplary embodiment of a discriminant model generation device according to the present invention. A discriminant model generation device 100 according to the present exemplary embodiment includes a storage unit 10, a label calculation unit 20, and a learning device 30.

The storage unit 10 stores learning data. Note that the learning data may be referred to as a sample. Further, the storage unit 10 may store data such as a parameter to be used by the label calculation unit 20 and the learning device 30 described later. The storage unit 10 is realized by, for example, a magnetic disk device or the like.

FIG. 2 is an explanatory view showing an example of learning data. The learning data exemplified in FIG. 2 indicates sales data of a certain product for each date. The learning data exemplified in FIG. 2 includes sales one week ago, a holiday flag indicating whether or not to be a holiday, a temperature, and sales. These data are used as explanatory variables in a discriminant model. Further, the determination result exemplified in FIG. 2 indicates whether or not the sales have exceeded 100 (1 in a case of exceeding, and 0 in a case of not exceeding).

The label calculation unit 20 calculates a label to be added to learning data, in accordance with a difference between a threshold value for discriminating a positive example or a negative example and a value of an objective variable included in the learning data. Specifically, for each learning data, the label calculation unit 20 calculates a label representing a more likelihood of a positive example as a value of an objective variable becomes larger as compared with a threshold value, and calculates a label representing a more likelihood of a negative example as a value of an objective variable becomes smaller as compared with a threshold value.

For example, a label representing a positive example is set to “1”, and a label representing a negative example is set to “0”. Then, a value closer to “1” is to represent a label representing a more likelihood of a positive example, and a value closer to “0” is to represent a label representing a more likelihood of a negative example. At this time, the label calculation unit 20 may calculate a label indicating a value closer to “1” as a value of an objective variable becomes larger as compared with a threshold value, and calculate a label indicating a value closer to “0” as a value of an objective variable becomes smaller as compared a threshold value. As described above, the label calculated in the present invention does not completely distinguish between a likelihood of a positive example and a likelihood of a negative example, but is a flexible label. Therefore, the label can be called a soft label (soft-Label). Whereas, as being opposed to the soft label, a label that completely distinguishes a likelihood of a positive example and a likelihood of a negative example (for example, a label representing a positive example is “1”, and a label representing a negative example is “0”), is described as a hard label.

The label calculation unit 20 may calculate the label by using a function that determines a value on the basis of a difference between an objective variable and a threshold value. The label calculation unit 20 may calculate the label by using, for example, a sigmoid function with which likelihoods of a positive example and a negative example are equal (0.5) when a value of an objective variable is equal to a threshold value, approach 1 as the value of the objective variable becomes larger than the threshold value, and approach 0 as the value of the objective variable becomes smaller than the threshold value.

When the threshold value is 0 and the value of the objective variable of data i is yᵢ, a sigmoid function f is expressed by the following Equation 1. Note that, in Equation 1, T is a temperature parameter.

$$[ Formula 1 ]$$

$$f = \frac{1}{1 + exp ( \frac{- ( {y}_{i} - θ )}{T} )} \qquad ( Equation 1 )$$

Note that a function used by the label calculation unit 20 to calculate a label is not limited to the sigmoid function. For example, when the label representing the positive example is “1” and the label representing the negative example is “0”, any contents may be adopted as long as the function is monotonically non-decreasing for the objective variable and has a value-range falling within [0,1].

FIG. 3 is an explanatory view showing an example of a result of calculating a label on the basis of learning data. The example shown in FIG. 3 shows a result of calculating a label on the basis of the above-described Equation 1. Here, the temperature parameter is set to T=10. In a case of a general method, for example, sales indicated by data of id=2 are 99, and the data is smaller than the threshold value 100 although being extremely close to the positive example. Therefore, the data of id=2 is simply used as data of a negative example (0).

However, in the present exemplary embodiment, for data close to a positive example, the label calculation unit 20 calculates a label indicating that data is close to the positive example among negative examples, even if the data is a negative example. In other words, even if learning data is discriminated to be a negative example when a value of an objective variable included in the learning data is compared with a threshold value, the label calculation unit 20 calculates a label representing a likelihood of a positive example for the learning data. Therefore, a more accurate discriminant model can be learned even when learning data is small, since the learning data can be used efficiently.

The learning device 30 learns a discriminant model by using learning data associated with a label calculated by the label calculation unit 20. Specifically, the learning device 30 generates a discriminant model in which whether or not a threshold value is exceeded is used as an objective variable, and a variable as exemplified in FIG. 2 is used as an explanatory variable. Note that, in the present exemplary embodiment, a soft label is used as a value corresponding to the objective variable of the learning data, instead of a hard label indicating “whether or not a threshold value is exceeded”. That is, learning is performed by treating the soft label just like an objective variable. For example, when an explanatory variable is defined as x, a soft label is defined as s, and a hard label is defined as y, (x, y) is used as learning data in learning of a general discriminant model. However, (x, s) is used as learning data in the present exemplary embodiment. Note that any method for the learning device 30 to perform learning may be adopted. The learning device 30 may learn the discriminant model by using, for example, logistic regression.

The label calculation unit 20 and the learning device 30 are realized by a processor (for example, a central processing unit (CPU), a graphics processing unit (GPU), or a field-programmable gate array (FPGA)) of a computer that operates in accordance with a program (a discriminant model generation program).

For example, the program may be stored in the storage unit 10, and the processor may read the program and operate as the label calculation unit 20 and the learning device 30 in accordance with the program. Further, a function of the recommended order quantity determination device may be provided in a software as a service (SaaS) format.

Each of the label calculation unit 20 and the learning device 30 may be realized by dedicated hardware. In addition, part or all of each component of each device may be realized by a general purpose or dedicated circuitry, a processor, or the like, or a combination thereof.

These may be configured by a single chip or may be configured by a plurality of chips connected via a bus. Part or all of each component of each device may be realized by a combination of the above-described circuitry and the like and a program.

Further, when part or all of each component of each device of the discriminant model generation device is realized by a plurality of information processing devices, circuitry, and the like, the plurality of information processing devices, circuitry, and the like may be arranged concentratedly or distributedly. For example, the information processing devices, the circuitry, and the like may be realized as a form in which each is connected via a communication network, such as a client server system, a cloud computing system, and the like.

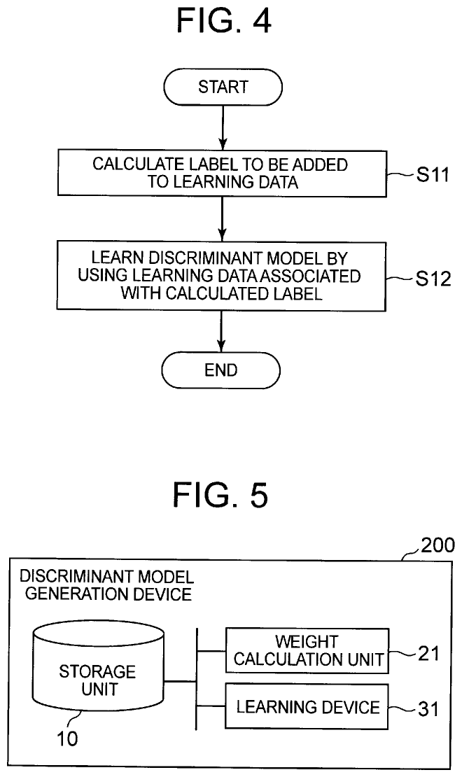

Next, an operation of the discriminant model generation device of the present exemplary embodiment will be described. FIG. 4 is a flowchart showing an operation example of the discriminant model generation device of the present exemplary embodiment. The label calculation unit 20 calculates a label to be added to learning data, in accordance with a difference between a threshold value for discriminating a positive example or a negative example and a value of an objective variable included in the learning data (step S11). Specifically, for each learning data, the label calculation unit 20 calculates a label representing a more likelihood of a positive example as a value of an objective variable becomes larger as compared with a threshold value, and calculates a label representing a more likelihood of a negative example as a value of an objective variable becomes smaller as compared with a threshold value. Then, the learning device 30 learns a discriminant model by using learning data associated with a calculated label (step S12).

As described above, in the present exemplary embodiment, the label calculation unit 20 calculates a label to be added to learning data, in accordance with a difference between a threshold value for discriminating a positive example or a negative example and a value of an objective variable included in the learning data, and the learning device 30 learns a discriminant model by using learning data associated with a calculated label. Therefore, a highly accurate discriminant model can be learned even when learning data is small.

### Second Exemplary Embodiment

Next, a second exemplary embodiment of the discriminant model generation device according to the present invention will be described. In the first exemplary embodiment, the method has been described in which the label calculation unit 20 calculates, for each learning data, a label representing a likelihood of a positive example or a likelihood of a negative example in accordance with a difference between a value of an objective variable and a threshold value. The present exemplary embodiment will describe a method of individually calculating, as a label, a weight in a case of positive example data (positive example weight) and a weight in a case of negative example data (negative example weight) for each learning data.

FIG. 5 is a block diagram showing a configuration example of the second exemplary embodiment of the discriminant model generation device according to the present invention. A discriminant model generation device 200 according to the present exemplary embodiment includes a storage unit 10, a weight calculation unit 21, and a learning device 31. Contents stored in the storage unit 10 are similar to those in the first exemplary embodiment.

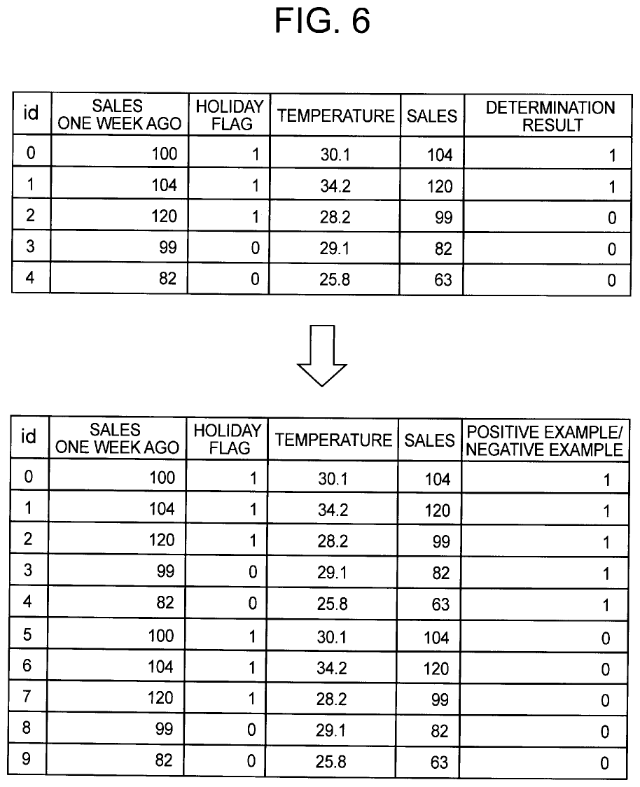

The weight calculation unit 21 generates positive example data and negative example data from learning data regardless of a value of an objective variable. FIG. 6 is an explanatory view showing an example of a process for generating positive example data and negative example data from learning data. The example exemplified in FIG. 6 indicates that the weight calculation unit 21 generates the learning data exemplified in FIG. 2 as positive example data and negative example data individually.

For example, the data of id=0 exemplified in FIG. 2 is positive example data based on a determination result. Whereas, in the present exemplary embodiment, data intentionally used as a negative example is generated from the positive example data. Specifically, the weight calculation unit 21 generates not only the positive example data of id=0 exemplified in FIG. 6 but also the negative example data of id=5 from the positive example data of id=0 exemplified in FIG. 2. Similarly, the weight calculation unit 21 generates positive example data of id=1 and negative example data of id=6 from the data of id=1 exemplified in FIG. 2

Similarly, in the present exemplary embodiment, data used as a positive example is also generated from negative example data. Specifically, the weight calculation unit 21 generates not only the negative example data of id=7 exemplified in FIG. 6 but also the positive example data of id=2 from the negative example data of id=2 exemplified in FIG. 2. Similarly, the weight calculation unit 21 generates positive example data of id=3 and negative example data of id=8 from the data of id=3 exemplified in FIG. 2, and generates positive example data of id=4 and negative example data of id=9 from the data of id=4 exemplified in FIG. 2.

For the generated positive example data, the weight calculation unit 21 calculates a positive example weight to be higher as a value of an objective variable becomes larger as compared with a threshold value. Further, for the generated negative example data, the weight calculation unit 21 calculates a negative example weight to be higher as a value of an objective variable becomes smaller as compared with a threshold value. The positive example weight and the negative example weight can be said to be a label of the first exemplary embodiment.

Specifically, the weight calculation unit 21 may calculate the positive example weight by a method similar to the method for the label calculation unit 20 to calculate a label in the first exemplary embodiment. For example, the weight calculation unit 21 calculates a positive example weight that becomes closer to “1” as a value of an objective variable becomes larger as compared with a threshold value. Then, the weight calculation unit 21 may calculate a negative example weight by subtracting the calculated positive example weight from 1. That is, when an i-th learning data is xᵢ and a weight of the positive example data (positive example weight) is wᵢ, the weight calculation unit 21 may calculate a weight of the negative example data as 1−wᵢ.

Further, the weight calculation unit 21 may calculate the positive example weight and the negative example weight by using a function for determining a value on the basis of a difference between an objective variable and a threshold value. Specifically, the weight calculation unit 21 may calculate the positive example weight by using the sigmoid function shown in Equation 1 above, and may calculate the positive example weight by using a function that is monotonically non-decreasing for a value of an objective variable and has a value-range falling within [0, 1].

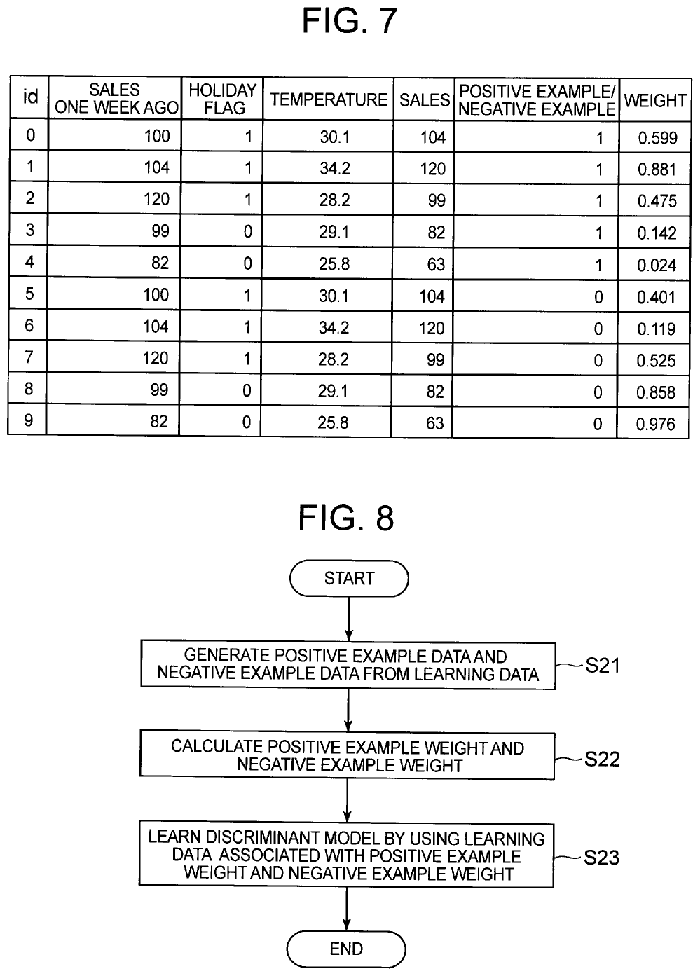

FIG. 7 is an explanatory view showing an example of a result of calculating a weight on the basis of learning data. Also in the example shown in FIG. 7, a weight is calculated based on the above Equation 1, and a temperature parameter T=10 is satisfied. For example, the data of id=5 exemplified in FIG. 7 is negative example data generated from data that is originally a positive example. However, in the present exemplary embodiment, it is possible to calculate a possible negative example weight by using a soft label. As described above, when the result exemplified in FIG. 7 is compared with the result exemplified in FIG. 3, a weight is calculated for a negative example data as well, so that the learning data can be increased.

For example, a sample whose value of an objective variable is close to a threshold value even if it is a negative example (for example, a case such as “a near miss” in data indicating the presence or absence of an accident) is considered to be a sample that is also useful as a positive example. In the present exemplary embodiment, even if learning data is discriminated to be a negative example when a value of an objective variable included in the learning data is compared with a threshold value, the weight calculation unit 21 calculates a label (that is, positive example data) indicating a likelihood of a positive example for the learning data. That is, by setting a positive example weight to such a sample, it becomes possible to increase the learning data.

In addition, the weight calculation unit 21 may add a constant C to the calculated weight wᵢ so that the learning device 31 described later can learn a hard label. That is, the weight calculation unit 21 may calculate wᵢ+C as the weight. Further, the weight calculation unit 21 may adjust a balance of the sum of weights of positive examples and the sum of weights of negative examples to 1:1 or the like, similarly to a response to an imbalanced problem in machine learning. For example, the weight calculation unit 21 may adjust the positive example weight to wᵢ/Σwᵢ and the negative example weight to (1−wᵢ)/(Σ1−wᵢ).

The learning device 31 learns a discriminant model by using learning data associated with a positive example weight or a negative example weight calculated by the weight calculation unit 21. Similarly to the first exemplary embodiment, the learning device 31 generates a discriminant model in which whether or not a threshold value is exceeded is used as an objective variable, and a variable as exemplified in FIG. 6 is used as an explanatory variable, by performing learning with use of weighted samples. Note that any method for the learning device 31 to perform learning may be adopted. The learning device 31 may learn the discriminant model by using, for example, logistic regression.

The weight calculation unit 21 and the learning device 31 are also realized by a processor of a computer that operates in accordance with a program (discriminant model generation program).

Next, an operation of the discriminant model generation device of the present exemplary embodiment will be described. FIG. 8 is a flowchart showing an operation example of the discriminant model generation device of the present exemplary embodiment. The weight calculation unit 21 generates positive example data and negative example data from learning data (step S21). The weight calculation unit 21 calculates a positive example weight and a negative example weight in accordance with a difference between a threshold value and a value of an objective variable included in the learning data (step S22). Specifically, the weight calculation unit 21 calculates a positive example weight to be larger as a value of an objective variable becomes larger as compared with a threshold value, and calculates a negative example weight to be larger as a value of an objective variable becomes smaller as compared with a threshold value. The learning device 31 learns a discriminant model by using learning data associated with the calculated positive example weight and negative example weight (step S23).

As described above, in the present exemplary embodiment, the weight calculation unit 21 generates positive example data and negative example data from learning data. At that time, the weight calculation unit 21 calculates, as a label, a positive example weight to be larger as a value of an objective variable becomes larger as compared with a threshold value, and calculates, as a label, a negative example weight to be larger as a value of an objective variable becomes smaller as compared with a threshold value. Therefore, in addition to the effects of the first exemplary embodiment, it becomes possible to use an existing method of learning with use of data of positive and negative examples.

### Third Exemplary Embodiment

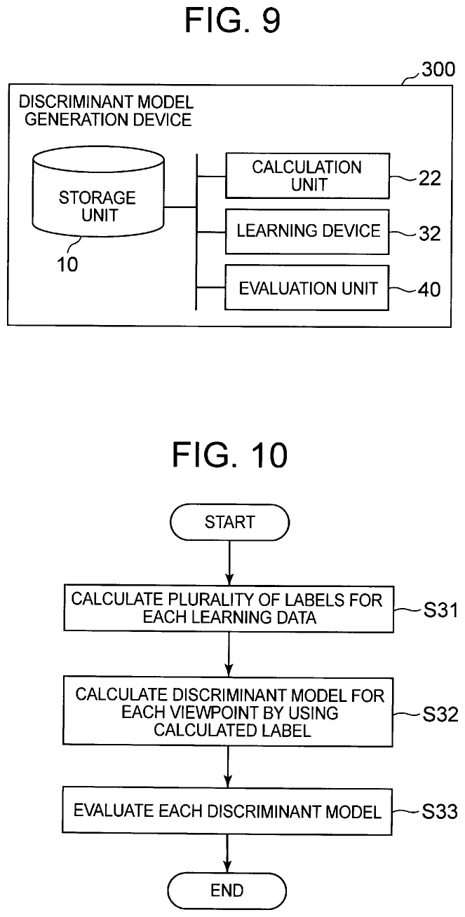

Next, a third exemplary embodiment of a discriminant model generation device according to the present invention will be described. In the present exemplary embodiment, a description is given to a method of learning a plurality of discriminant models and selecting a discriminant model with higher evaluation. FIG. 9 is a block diagram showing a configuration example of the third exemplary embodiment of the discriminant model generation device according to the present invention. A discriminant model generation device 300 according to the present exemplary embodiment includes a storage unit 10, a calculation unit 22, a learning device 32, and an evaluation unit 40. Contents stored in the storage unit 10 are similar to those in the first exemplary embodiment.

The calculation unit 22 calculates a label to be added to learning data. The label calculated by the calculation unit 22 may be a label calculated by the label calculation unit 20 of the first exemplary embodiment, or may be a positive example weight and a negative example weight calculated by the weight calculation unit 21 of the second exemplary embodiment.

Further, the calculation unit 22 of the present exemplary embodiment calculates a plurality of labels for each learning data on the basis of a plurality of viewpoints. Any method for selecting the viewpoint may be adopted. For example, when calculating a label by using Equation 1 above, the calculation unit 22 may calculate a plurality of labels by changing a temperature parameter T. That is, the calculation unit 22 may calculate a plurality of labels while changing a change degree in accordance with a difference between a threshold value and a value of an objective variable. Further, the calculation unit 22 may calculate a plurality of labels by using a plurality of types of functions.

The learning device 32 learns a discriminant model for each of the viewpoints by using the label calculated by the calculation unit 22. The learning method performed by the learning device 32 may simply be determined in accordance with contents of the label created by the calculation unit 22.

The evaluation unit 40 evaluates each discriminant model learned by the learning device 32. The evaluation unit 40 may simply perform evaluation by using any method such as, for example, cross-validation. Further, the evaluation unit 40 may output an evaluation result.

The calculation unit 22, the learning device 32, and the evaluation unit 40 are also realized by a processor of a computer that operates in accordance with a program (discriminant model generation program).

Next, an operation of the discriminant model generation device of the present exemplary embodiment will be described. FIG. 10 is a flowchart showing an operation example of the discriminant model generation device of the present exemplary embodiment. The calculation unit 22 calculates a plurality of labels for each learning data on the basis of a plurality of viewpoints (step S31). The learning device 32 learns a discriminant model for each of the viewpoints by using the label calculated by the calculation unit 22 (step S32). The evaluation unit 40 evaluates each discriminant model learned by the learning device 32 (step S33). As described above, in the present exemplary embodiment, the calculation unit 22 calculates a plurality of labels for each learning data on the basis of a plurality of viewpoints, and the learning device 32 learns a discriminant model for each of the viewpoints. Then, the evaluation unit 40 evaluates each learned discriminant model. Therefore, in addition to the effects of the first exemplary embodiment and the second exemplary embodiment, it becomes possible to select a more accurate discriminant model.

### Fourth Exemplary Embodiment

Next, a fourth exemplary embodiment of the present invention will be described. The first to third exemplary embodiments have described the discriminant model generation device that generates a discriminant model on the basis of a calculated label. Whereas, one device may be realized by a function of calculating a label to be associated with learning data.

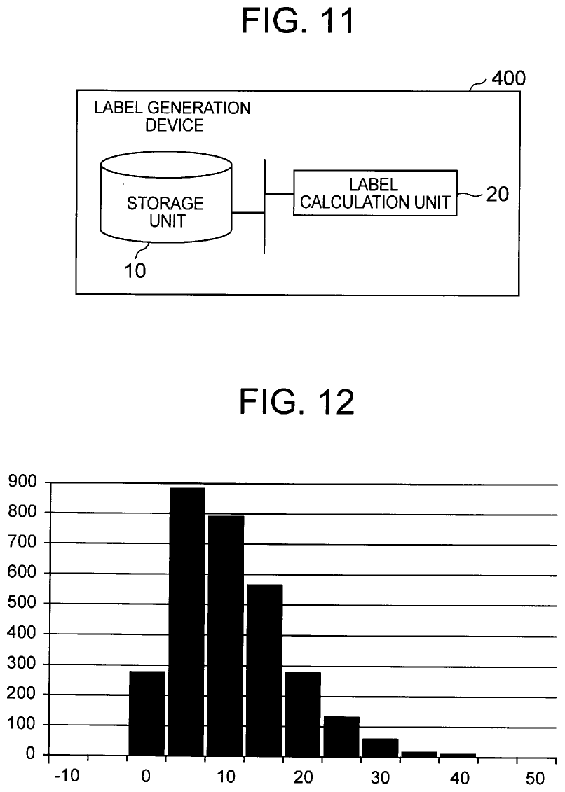

FIG. 11 is a block diagram showing an exemplary embodiment of a label generation device according to the present invention. A label generation device 400 of the present exemplary embodiment includes a storage unit 10 and a label calculation unit 20. That is, the label generation device 400 of the present exemplary embodiment corresponds to a configuration in which the learning device 30 is removed from the discriminant model generation device 100 of the first exemplary embodiment. Note that the label calculation unit 20 may be realized by the weight calculation unit 21 in the second exemplary embodiment or the calculation unit 22 in the third exemplary embodiment.

By generating learning data associated with a label with use of the label generation device exemplified in FIG. 11, efficient learning data can be generated from a small amount of learning data.

### Example

Hereinafter, the present invention will be described with reference to specific examples and drawings, but the scope of the present invention is not limited to the contents described below.

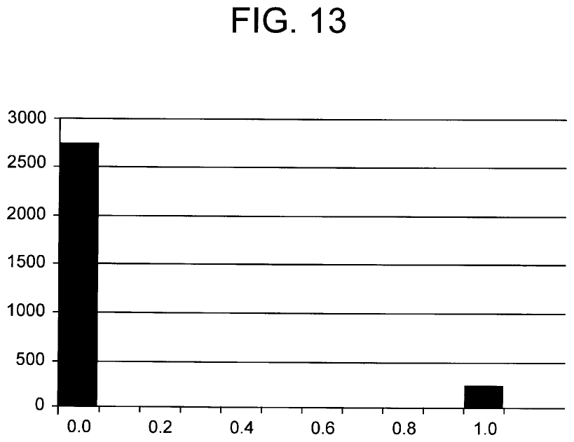

FIG. 12 is an explanatory view showing a distribution of learning data according to the present example. Samples exemplified in FIG. 12 are 3000 samples according to a normal distribution. In the present example, a threshold value was set to 20. FIG. 13 shows an example of a result of classifying samples into positive example data and negative example data on the basis of the threshold value. In the present example, the number the positive example data is 255, the number of the negative example data is 2745, and a ratio of the number of the positive example data is less than 10%.

Further, in the present example, a weight wᵢ of the positive example data was calculated by Equation 1 shown above. In addition, Equation 2 exemplified below was used as a loss function used for learning.

[Formula 2]

L=Σᵢwᵢ(y log(ŷ)+(1−y)log(1−ŷ)) (Equation 2)

In addition, a part of the sample exemplified in FIG. 12 was used as learning data, and a part was used for evaluation. Specifically, area under the curve (AUC) evaluation was performed on a generated discriminant model by using the sample the evaluation. This evaluation corresponds to the processing performed by the evaluation unit 40 described above.

First, using a general method, the samples were classified into a positive example (1) and a negative example (0), and then a discriminant model was generated. Whereas, in discrimination using a discriminant model generated by using the present invention (hereinafter, referred to as soft-Label discrimination), the temperature parameter T of Equation 1 shown above is changed to 12 types (T=0.001, 0.003, 0.01, 0.03, 0.1, 0.3, 1, 3, 10, 30, 100, 300) to generate a label and generate a discriminant model.

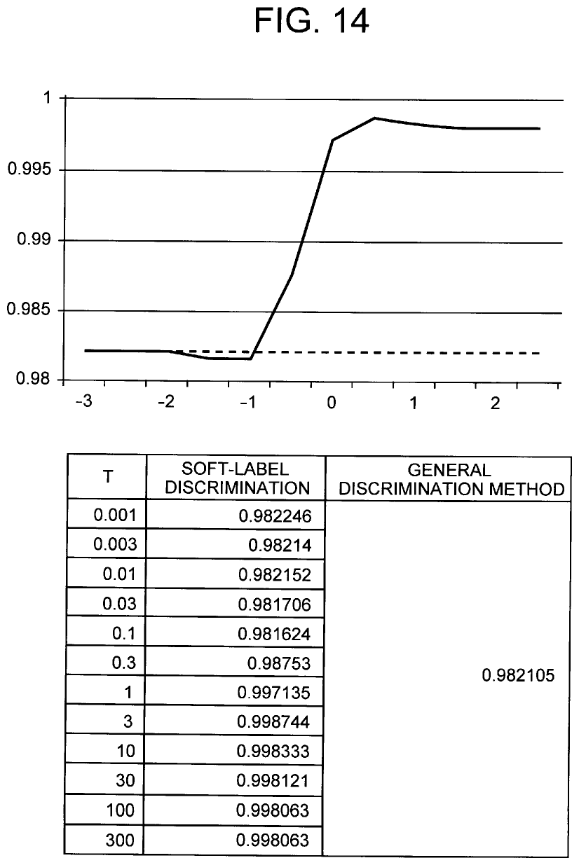

FIG. 14 is an explanatory view showing an example of an evaluation result. A graph shown by a dashed line exemplified in FIG. 14 shows an AUC value (AUC=0.982) when a general method is used. Further, a graph shown by a solid line exemplified in FIG. 14 shows an AUC value when a value of the temperature parameter T is changed in the soft-label discrimination. As exemplified in FIG. 14, it was confirmed that increasing the value of the temperature parameter T improves accuracy as compared with a case where a general method is used.

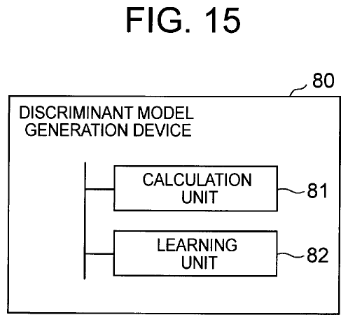

Next, an outline of the present invention will be described. FIG. 15 is a block diagram showing an outline of a discriminant model generation device according to the present invention. A discriminant model generation device 80 according to the present invention includes: a calculation unit 81 (for example, the label calculation unit 20) that calculates a label to be added to learning data, in accordance with a difference between a threshold value (for example, the threshold value θ) for discriminating a positive example or a negative example and a value of an objective variable included in the learning data; and a learning unit 82 (for example, the learning device 30) that learns a discriminant model by using learning data associated with a calculated label.

Such a configuration allows a highly accurate discriminant model to be learned even when learning data is small.

Specifically, the calculation unit 81 may calculate, for each learning data, a label representing a more likelihood of a positive example as a value of an objective variable becomes larger as compared with a threshold value, and calculate a label representing a more likelihood of a negative example as a value of an objective variable becomes smaller as compared with a threshold value.

Further, the calculation unit 81 (for example, the weight calculation unit 21) may generate positive example data and negative example data from learning data, calculate, as a label, a positive example weight to be larger as a value of an objective variable becomes larger as compared with a threshold value, and calculate, as a label, a negative example weight to be larger as a value of an objective variable becomes smaller as compared with a threshold value.

Further, the calculation unit 81 may adjust a positive example weight and a negative example weight on the basis of the sum of the positive example weight and the sum of the negative example weight.

Further, the calculation unit 81 may calculate the label by using a function that is monotonically non-decreasing for an objective variable and takes a value within a value-range of 0 to 1.

Specifically, the calculation unit 81 may calculate a label by using a sigmoid function (for example, Equation 1 shown above) with which a likelihood of a positive example and a likelihood of a negative example become equal when a value of an objective variable is equal to a threshold value.

Some or all of the above exemplary embodiments may be described as in the following supplementary notes, but are not limited to the following.

(Supplementary note 1) A discriminant model generation device including: a calculation unit that calculates a label to be added to learning data, in accordance with a difference between a threshold value for discriminating a positive example or a negative example and a value of an objective variable included in the learning data; and a learning unit that learns a discriminant model by using learning data associated with a calculated label.

(Supplementary note 2) The discriminant model generation device according to Supplementary note 1, in which, for each learning data, the calculation unit calculates a label representing a more likelihood of a positive example as a value of an objective variable becomes larger as compared with a threshold value, and calculates a label representing a more likelihood of a negative example as a value of an objective variable becomes smaller as compared with a threshold value.

(Supplementary note 3) The discriminant model generation device according to Supplementary note 1 or 2, in which the calculation unit generates positive example data and negative example data from learning data, calculates, as a label, a positive example weight to be larger as a value of an objective variable becomes larger as compared with a threshold value, and calculates, as a label, a negative example weight to be larger as a value of an objective variable becomes smaller as compared with a threshold value.

(Supplementary note 4) The discriminant model generation device according to Supplementary note 3, in which the calculation unit adjusts a positive example weight and a negative example weight, based on a sum of the positive example weight and a sum of the negative example weight.

(Supplementary note 5) The discriminant model generation device according to any one of Supplementary notes 1 to 4, in which the calculation unit calculates a label by using a function that is monotonically non-decreasing for an objective variable and takes a value within a value-range of 0 to 1.

(Supplementary note 6) The discriminant model generation device according to any one of Supplementary notes 1 to 5, in which, for learning data that is discriminated to be a negative example when a value of an objective variable included in the learning data is compared with a threshold value, a label representing a likelihood of a positive example is calculated.

(Supplementary note 7) The discriminant model generation device according to any one of Supplementary notes 1 to 6, in which the calculation unit calculates a label by using a sigmoid function with which a likelihood of a positive example and a likelihood of a negative example are equal when a value of an objective variable is equal to a threshold value.

(Supplementary note 8) The discriminant model generation device according to any one of Supplementary notes 1 to 7, further including an evaluation unit that evaluates a learned discriminant model, in which the calculation unit calculates a plurality of labels for each learning data based on a plurality of viewpoints, the learning unit learns a discriminant model for each of the viewpoints, and the evaluation unit evaluates each learned discriminant model.

(Supplementary note 9) A discriminant model generation method including: calculating a label to be added to learning data, in accordance with a difference between a threshold value for discriminating a positive example or a negative example and a value of an objective variable included in the learning data; and learning a discriminant model by using learning data associated with a calculated label.

(Supplementary note 10) The discriminant model generation method according to Supplementary note 9, further including, for each learning data, calculating a label representing a more likelihood of a positive example as a value of an objective variable becomes larger as compared with a threshold value, and calculating a label representing a more likelihood of a negative example as a value of an objective variable becomes smaller as compared with a threshold value.

(Supplementary note 11) The discriminant model generation method according to Supplementary note 9 or 10, further including: generating positive example data and negative example data from learning data; calculating, as a label, a positive example weight to be larger as a value of an objective variable becomes larger as compared with a threshold value; and calculating, as a label, a negative example weight to be larger as a value of an objective variable becomes smaller as compared with a threshold value.

(Supplementary note 12) A discriminant model generation program for causing a computer to execute: a calculation process of calculating a label to be added to learning data, in accordance with a difference between a threshold value for discriminating a positive example or a negative example and a value of an objective variable included in the learning data; and a learning process of learning a discriminant model by using learning data associated with a calculated label.

(Supplementary note 13) The discriminant model generation program according to Supplementary note 12, in which, in the calculation process, for each learning data, the computer is caused to: calculate a label representing a more likelihood of a positive example as a value of an objective variable becomes larger as compared with a threshold value; and calculate a label representing a more likelihood of a negative example as a value of an objective variable becomes smaller as compared with a threshold value.

(Supplementary note 14) A label generation device including: a calculation unit that calculates a label to be added to learning data, in accordance with a difference between a threshold value for discriminating a positive example or a negative example and a value of an objective variable included in the learning data.

Although the present invention has been described with reference to the exemplary embodiments and examples, the present invention is not limited to the above exemplary embodiments and examples. Various changes that can be understood by those skilled in the art can be made to the configuration and details of the present invention within the scope of the present invention.

This application claims priority based on Japanese Patent Application 2017-214687, filed on Nov. 7, 2017, the entire disclosure of which is incorporated herein.

### REFERENCE SIGNS LIST

10 Storage unit
20 Label calculation unit
21 Weight calculation unit
22 Calculation unit
30, 31, 32 Learning device
40 Evaluation unit
100, 200, 300 discriminant model generation device
400 Label generation device

1. A discriminant model generation device comprising a hardware processor configured to execute a software code to:
calculate a label to be added to learning data, in accordance with a difference between a threshold value for discriminating a positive example or a negative example and a value of an objective variable included in the learning data; and
learns learn a discriminant model by using learning data associated with a calculated label.

2. The discriminant model generation device according to claim 1, wherein the hardware processor is configured to execute a software code to calculate, for each learning data, a label representing a more likelihood of a positive example as a value of an objective variable becomes larger as compared with a threshold value, and calculate a label representing a more likelihood of a negative example as a value of an objective variable becomes smaller as compared with a threshold value.

3. The discriminant model generation device according to claim 1, wherein the hardware processor is configured to execute a software code to:
generate positive example data and negative example data from learning data;
calculate, as a label, a positive example weight to be larger as a value of an objective variable becomes larger as compared with a threshold value; and
calculate, as a label, a negative example weight to be larger as a value of an objective variable becomes smaller as compared with a threshold value.

4. The discriminant model generation device according to claim 3, wherein the hardware processor is configured to execute a software code to
adjust a positive example weight and a negative example weight, based on a sum of the positive example weight and a sum of the negative example weight.

5. The discriminant model generation device according to claim 1, wherein the hardware processor is configured to execute a software code to
calculate a label by using a function that is monotonically non-decreasing for an objective variable and takes a value within a value-range of 0 to 1.

6. The discriminant model generation device according to claim 1, wherein the hardware processor is configured to execute a software code to calculate a label representing a likelihood of a positive example for learning data that is discriminated to be a negative example when a value of an objective variable included in the learning data is compared with a threshold value.

7. The discriminant model generation device according to claim 1, wherein the hardware processor is configured to execute a software code to
calculate a label by using a sigmoid function with which a likelihood of a positive example and a likelihood of a negative example are equal when a value of an objective variable is equal to a threshold value.

8. The discriminant model generation device according to claim 1,
wherein the hardware processor is configured to execute a software code to:
calculate a plurality of labels for each learning data based on a plurality of viewpoints;
learn a discriminant model for each of the viewpoints; and
evaluate each learned discriminant model.

9. A discriminant model generation method comprising:
calculating a label to be added to learning data, in accordance with a difference between a threshold value for discriminating a positive example or a negative example and a value of an objective variable included in the learning data; and
learning a discriminant model by using learning data associated with a calculated label.

10. The discriminant model generation method according to claim 9, further comprising:
for each learning data, calculating a label representing a more likelihood of a positive example as a value of an objective variable becomes larger as compared with a threshold value, and calculating a label representing a more likelihood of a negative example as a value of an objective variable becomes smaller as compared with a threshold value.

11. The discriminant model generation method according to claim 9, further comprising:
generating positive example data and negative example data from learning data; and
calculating, as a label, a positive example weight to be larger as a value of an objective variable becomes larger as compared with a threshold value, and calculating, as a label, a negative example weight to be larger as a value of an objective variable becomes smaller as compared with a threshold value.

12. (canceled)

13. (canceled)

14. A label generation device comprising a hardware processor configured to execute a software code to
calculate a label to be added to learning data, in accordance with a difference between a threshold value for discriminating a positive example or a negative example and a value of an objective variable included in the learning data.
